(19) United States
(12) Patent Application Publication
(10) Pub. No.: US 2026/0284762 A1
(43) Pub. Date: Sep. 24, 2026

(54) METHOD FOR THE CONTINUOUS GENERATING GRINDING OF GEARS, AND PROFILING METHOD

(71) Applicant: GLEASON SWITZERLAND AG, Studen (CH)

(72) Inventors: Johannes Brogni, Dotzigen (CH); Andreas Senn, Ammerzwil (CH)

(21) Appl. No.: 19/153,640

(22) PCT Filed: Feb. 8, 2024
(86) PCT No.: PCT/EP2024/053220

§ 371 Date: Aug. 5, 2025

(30) Foreign Application Priority Data
Feb. 10, 2023 (DE) 10 2023 000 427.8

(51) Int. Cl. B23F 21/02; B23F 11/00; B23F 19/00; B23F 23/12; B24B 53/075

(52) U.S. Cl. CPC B23F 21/026; B23F 11/00; B23F 19/00; B23F 23/1225; B24B 53/075

(57) ABSTRACT

A method for the hard-fine machining of gear teeth on workpieces using geometrically undefined cutting edges by means of generating grinding, in which a grinding worm, in particular a multi-start grinding worm with bonded abrasive grains made of, in particular, CBN or diamond, is brought into machining engagement with a gear tooth at a machining position and is reprofiled after machining one or more workpieces of a workpiece batch, thereby undergoing material removal and thus reducing the center pitch diameter of the grinding worm before it is used for additional machining, wherein during the reprofiling, a profiling means is positioned relative to the worm thread orientation by means of a rotary axis, wherein the material removal takes place at a profiling position which differs in particular from the machining position, with removal of a metallic material that binds the abrasive grains.

The invention relates to a method for the hard-fine machining of gear teeth on workpieces using geometrically undefined cutting edges by means of generating grinding, in which a grinding worm, in particular a multi-start grinding worm with bonded abrasive grains made of, in particular, CBN or diamond, is brought into machining engagement with a gear tooth at a machining position and is reprofiled after machining one or more workpieces of a workpiece batch, thereby undergoing material removal and thus reducing the center pitch diameter of the grinding worm before it is used for additional machining, wherein during the reprofiling, a profiling means is positioned relative to the worm thread orientation by means of a rotary axis.

The generating grinding of gears is well known to a person skilled in the art as one of the dominant methods for the hard-fine machining of gear teeth. The grinding worms used for this purpose have been developed in accordance with two different tool strategies.

For example, there are galvanically coated metallic worm bodies with a fixedly defined center pitch diameter and a comparatively long service life, which, however, eventually wear out due to the wear of continuous machining and have to be reconditioned by recoating, so-called non-dressable worms (T. Bausch, Innovative Zahnradfertigung, 3rd Edition, p. 519, Fig. 14.4-8).

On the other hand, so-called dressable grinding worms have taken root, with ceramic or resin-bonded abrasive grains. As soon as these dressable grinding worms no longer cut sufficiently sharply, they are dressed, also called resharpening or reprofiling, which results in material removal with each reprofiling step, and the grinding worm becomes smaller and smaller, that is, its center pitch diameter changes (T. Bausch, see above, same figure).

The time required for reprofiling depends on the dressing technology used. If, for example, dressing rolls are used such that the dressing process takes place in line contact and continuously with the grinding worm rotating and a correspondingly aligned axial displacement of the dresser, the reprofiling process only takes such a short time that it can even be carried out on the generating grinding machine itself, with a correspondingly short interruption to the main machining process.

In this aspect, there are several variants as well; either the grinding worm is pivoted from its generating grinding machining position to a dressing position, is dressed there and pivoted back again, or it remains entirely at its machining position and a dresser is moved to the grinding worm and assumes approximately the position at which the workpiece to be ground is otherwise positioned, as disclosed, for example, in EP 1 146 983B 1 .

The invention is based on the object of further developing a method of the type mentioned above with regard to a satisfactory combination of the total service life of the grinding worm, process accuracy, and service life between two reprofiling processes.

From a process engineering point of view, this object is achieved by a further development of the method of the type mentioned above, which is substantially characterized in that the material removal takes place at a profiling position which differs in particular from the machining position, with removal of a metallic material (M) that binds the abrasive grains.

The invention is based on the realization that, despite the quite complex geometry of a grinding worm with its worm threads, reprofiling is still possible in spite of a metallic binding material, and that the longer time required for this can be well accepted compared to conventional dressing, in particular if the profiling position is different from the generating grinding machining position and the grinding worm has to be removed from its generating grinding clamping in a generating grinding machine.

Ideally, at least two, in particular more than two, even more than four, in particular more than six of the grinding worms suitable for the workpiece batches being machined are available for the method and can be used for the method in alternating rotation. In this context, it is particularly preferred that a grinding worm change/reprofiling only takes place after a number of workpieces of at least 600, preferably of at least 1000, in particular at least 2000 have been ground in generating grinding with a worm.

In a further preferred embodiment, it is provided that the material removal takes place by carrying out a relative movement between the profiling means and the grinding worm, said movement including at least two movement axes, in particular linear movement axes.

The path of this relative movement is preferably a zigzag path in an axial section plane through the grinding worm rotation axis, which follows the worm thread profile. In the case of a multi-start worm, the reprofiling is therefore not carried out start by start, but the movement path crosses thread profiles belonging to different starts.

In another preferred embodiment, it is provided that the grinding worm is rotated/turned about its axis during the material removal or in phases of interrupted material removal.

The reprofiling is preferably carried out segment by segment with an azimuthal segmentation with respect to the worm rotation axis. If the reprofiling takes place at a preset worm rotation position (apart from any additional corrective movements) and material is thus removed in discrete reprofiling steps over the circumference of the grinding worm, it is preferred that in one or more roughing passes, the grinding worm rotation axis is driven in increments of at least 2 degrees, preferably at least 5 degrees, but also more than 10 degrees, and for one or more finishing passes, in particular the last reprofiling pass, it is driven in increments of at least 0.5 degrees, preferably at least 1 degree and/or not more than 30 degrees, more preferably not more than 20 degrees, in particular not more than 10 degrees. More preferably, the quotient of 360 degrees and the number of worm starts is an integer multiple of the increment.

Such reprofiling, which is discontinuous in the azimuthal direction, also has the advantage that the resulting polygon-like surface structure results in favorable properties during grinding, see below. In an alternative embodiment, the grinding worm may also rotate continuously (but in particular with a non-constant speed) and thus be profiled in a similar way to line dressing.

In a further preferred embodiment, it is provided that heat involved in the material removal is dissipated via a liquid, for this purpose in particular both the profiling means and the worm region that is currently being reprofiled are immersed in a liquid bath. This results in more efficient heat dissipation. In this context, it is also preferred that the liquid in the liquid bath is replaced regularly, in particular even continuously. This means that the removed material may be removed immediately as appropriate.

In another preferred embodiment, it is provided that a worm thread orientation in the reprofiling region is set, via the rotary axis, in a predetermined direction with respect to a plane extending orthogonally to the worm rotation axis. In this way, even profiling means with geometric limitations may be used.

In this context, it is preferably provided that the profiling means has a region under tensile stress along this predetermined direction, said region extending longitudinally along this direction. Therefore, the profiling means has a geometric shape that differs significantly from the dressing rolls commonly used for the reprofiling of grinding worms.

In a further preferred embodiment, it is provided that the relative positioning of the profiling means and the grinding worm thread orientation is based on an absolute movement of the grinding worm. This makes it easier to maintain the tensile stress and does not require any effort to access the profiling means.

In another preferred embodiment, it is provided that continuously consecutive portions of the profiling means enter the region of material removal, in particular in a continuously consecutive fashion. This increases the reprofiling accuracy.

In yet another preferred embodiment, it is provided that the material removal is carried out by means of electrical discharge machining, in particular by means of wire eroding. This further development is based on the additional surprising finding that, despite the complex worm thread geometry, the measures explained above allow sufficient machining accuracy even for the wire eroding method, which has been known as such for more than 60 years.

In terms of device technology, a hard-fine machining tool using geometrically undefined cutting edges in the form of a grinding worm for the generating grinding of gears for a method according to any of the preceding aspects is provided. It is preferably provided that the grinding worm, after the initial profiling, still has a radial reprofiling reserve of at least 1 mm, preferably at least 2 mm, more preferably at least 5 mm, and in particular at least 10 mm. During the manufacture of the blank, metallic binding material may be sintered with the abrasive grains, preferably on a metallic main body (positioned radially inwardly), which is preferably made of steel and more preferably embodied as a shaft and in particular hollow, in order to be able to be received by a mandrel. In another preferred embodiment, it is provided that the outer diameter of the grinding worm is less than 300 mm, more preferably less than 200 mm, in particular less than 120 mm after the initial profiling.

In another preferred embodiment, the grain size of the abrasive grains is not larger than B151/D151, more preferably not larger than B91/D91, in particular not larger than B64/D64. The metallic binding material of the grinding worm is not particularly restricted; for example, a material containing or consisting of bronze or brass is preferred, but other conductive metallic materials are also considered, preferably with a melting point below 1000 degrees Celsius.

In another preferred embodiment, a calibration device is provided for retrieving a defined rotational angular position of the grinding worm in the profiling device. This could be realized in the form of a mandrel that can only be clamped in a defined rotational position and supports the worm in a defined rotational position, or by means of a planar tangential plane region that is provided, for example, axially subsequent to an axial worm end and extending orthogonally to the radial direction on the worm rotation axis.

The calibration device enables a reliable initial adjustment of the position of the eroding wire during reprofiling in the shift direction, that is, along an axial axis of the degrees of freedom of movement of a profiling device, to match the worm thread.

With regard to reprofiling, the invention provides a method for reprofiling a grinding worm according to claim 9, comprising the steps of removing material and the relative positioning therefor according to claim 1 and in particular one or more steps of the characterizing features of claims 2 to 8. The advantages of this reprofiling process will be apparent from the above explanations of the preceding claims.

Accordingly, a profiling device for such profiling is also within the scope of the invention, that is, a profiling device for profiling a grinding worm embodied according to claim 9, with a positioning device having a rotary axis for the relative positioning of a profiling means with respect to the worm thread orientation, and in particular a liquid-filled receiving space for receiving at least one region of the grinding worm undergoing material removal as well as an abrasive region of the profiling means. The advantages of such a profiling device will also be already apparent from the above explanations.

In a simple design variant of such a profiling device, it can be provided to couple a positioning device with a rotatable and twistable receptacle for receiving a grinding worm and to integrate this coupled device into a system already having two linear positioning axes, such as, for example, commercially available eroding devices.

However, it is understood that a targeted redesign of a suitable wire eroding machine may also be considered, including the possibility of integrating it into a generating grinding machine and being able to use the movement axes of the generating worm during generating grinding for profiling. In the latter case, the grinding oil is also preferably used as a dielectric medium during generating grinding.

In additional preferred embodiments, a profiling device according to claim 11 is provided, comprising a device for rotating the grinding worm about its own axis of rotation and an additional positioning system with at least two additional degrees of freedom of movement for the relative position between the grinding worm and the profiling means, wherein one degree of freedom has a movement component in the plane extending orthogonally to the worm rotation axis and the other additional degree of freedom has at least one directional component parallel to the worm rotation axis.

In another preferred embodiment, a profiling device according to claim 12 is provided, comprising a controller which, in an operating mode with a positioned rotary axis and a positioned rotational position of the grinding worm, allows a relative movement along a zigzag path involving the two additional degrees of freedom of movement and corresponding to the worm profile in axial section.

In another preferred embodiment, a profiling device according to any of claims 11 to 13 is provided, wherein said/a control device of the profiling device, in a second operating mode, superimposes superimposed movements of a positioning and a zigzag path, in order to subject the surfaces of the worm threads to a modification which, in particular, modifies a profile angle modification, a profile line crowning, a tip and/or root relief, in order to create a corresponding modification on the generating-ground workpiece during generating grinding with the grinding worm profiled in this modified way, wherein the modification profiled onto the grinding worm includes, in particular, a coordinated superposition of these modifications, and the modification includes a correction compensating for the additional profiling and the resulting changed center pitch diameter.

In particular, it is provided that the positioning movements and feed movements during the profiling pass are performed automatically by the control device of the profiling device and are also performed by means of closed-loop control. As is usual during eroding, in addition to the geometric parameters to be created, additional input parameters such as machining fineness entered as a radius and a desired cutting performance may be specified/entered, and a typical erosion software function automatically sets the additional erosion parameters. For example, the feed rate may be controlled as a function of the amperage, the distance between the wire and the worm thread surface to be machined and the desired rate of removal. It will be understood that, depending on the material selected for the grinding worm, a testing and learning phase may be used to determine which wire erosion parameters lead to what kind of removal, and to determine this by means of conventional measurement of generating worms, and that the parameters of the profiling device embodied as an eroding machine as well as the feed rates are set in a mutually coordinated manner, in order to first profile and then reprofile, respectively, the grinding worm profile designed in the usual way for generating grinding.

In order to make the aforementioned modifications to the grinding worm profile to create or compensate for corresponding tooth flank modifications on the generating-ground workpieces, the wire axis is not available as a degree of freedom in the wire eroding process. Since, among other things, discontinuous profiling may be selected as described above, the available degrees of freedom are basically δA, δB, δX, δY as modifying superimposed movements for forming the worm thread profiles, in addition to the aforementioned basic profiling via the axial and radial positioning axes in the form of linear movement axes X, Y as well as rotation axis B and pivot axis A (the relative rotary positioning axis), and thus similar degree of freedom options as with so-called mechanical line dressing. The “polygon-like structures” produced by azimuthally discrete reprofiling may be refined accordingly by refining the increment, such that a close correspondence to a line dressing contact region may be achieved in this aspect as well.

It will be understood that the profiling device described above may also be used for the initial profiling of the grinding worm according to the invention. For this purpose, a comparatively slow, single “carve out” pass through the solid material in terms of radial depth may be performed. Of course, when the driving continues in increments in the direction of worm rotation, an axial displacement by the corresponding pitch proportion must be performed, in order to maintain the worm thread geometry, corresponding to the kinematic coupling between dresser and worm rotation that occurs during conventional dressing (axial displacement to worm rotation).

In a preferred method design of generating grinding, it is also provided that the generating grinding worm is multi-started with a number of starts of preferably at least 3, more preferably at least 4, in particular at least 5, and/or has a center pitch angle of more than 2 degrees, preferably more than 4 degrees. A value in the interval [0.5; 5] is preferred as the modulus of the worm.

In another preferred method design, as already explained above, it is provided that a polygon-like surface structure in the circumferential direction of the generating grinding worm is created during reprofiling. This contributes positively to the reduction of grinding pressure and also results in an improved supply of coolant/lubricant.

The method aspect of reprofiling by electrical discharge machining, in particular wire eroding of generating grinding worms, could also be used for bonding materials that are non-metallic in nature but are nevertheless conductive or made conductive, such as carbon compounds or synthetic resin bonds made conductive by, for example, metal additives. This aspect is also disclosed by the invention as being independent and worthy of protection in its own right. The invention thus also relates to a method for the hard-fine machining of gear teeth on workpieces using geometrically undefined cutting edges by means of generating grinding, in which a grinding worm, in particular a multi-start grinding worm with bonded abrasive grains made of, in particular, CBN or diamond, is brought into machining engagement with a gear tooth at a machining position and is reprofiled after machining one or more workpieces of a workpiece batch, thereby undergoing material removal and thus reducing the center pitch diameter of the grinding worm before it is used for additional machining, wherein during the reprofiling, a profiling means is positioned relative to the worm thread orientation by means of a rotary axis, wherein the material removal takes place at a profiling position which differs in particular from the machining position, with removal of a conductive or conductible material that binds the abrasive grains by means of electrical discharge machining, in particular by means of wire eroding. The above statements regarding corresponding generating worms and initial profiling apply analogously.

In generating grinding worms with differently designed axial regions that are also contemplated by the invention, one or more of these regions may be made of a non-metallic but conductive binding material, for example a polishing region, and this region may nevertheless be reprofiled together with the other, for example metallic, region(s) for roughing and/or finishing generating grinding.

Further features, details and advantages of the invention will be apparent from the following description with reference to the accompanying figures, wherein:

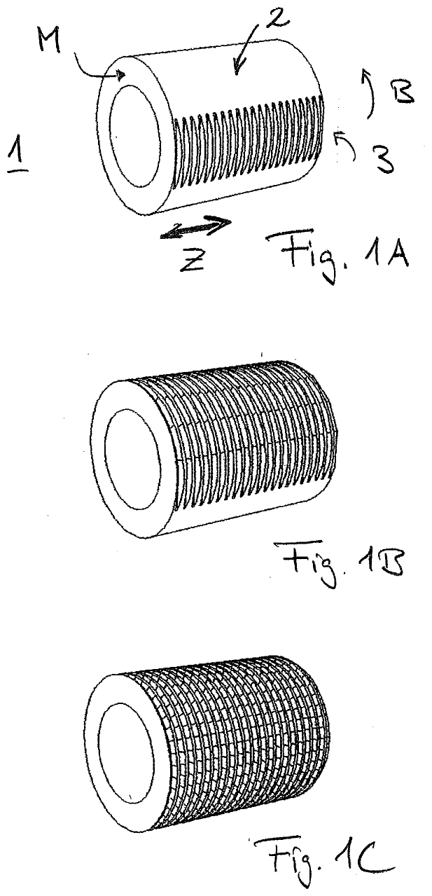

FIG. 1A to 1C schematically illustrate azimuthally discrete profiling,

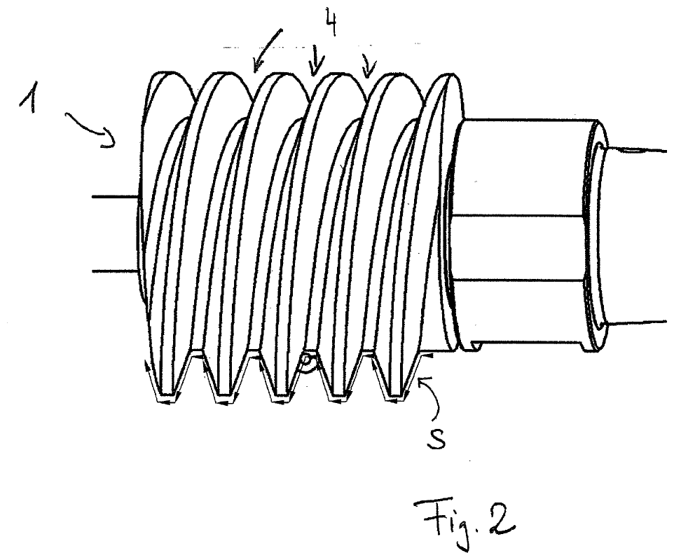

FIG. 2 depicts the path of a feed movement during reprofiling,

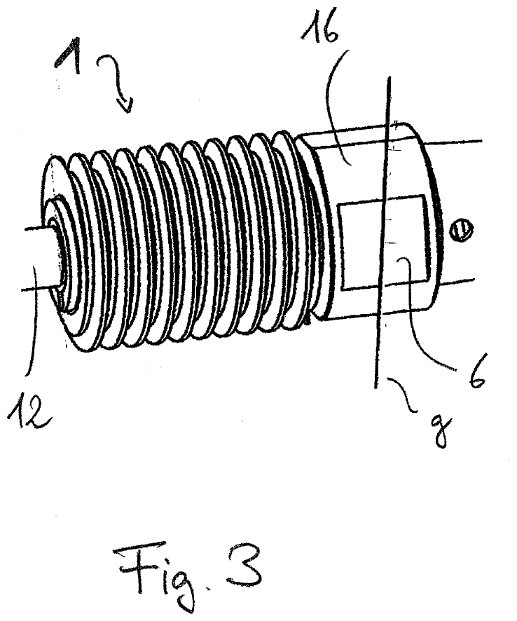

FIG. 3 depicts the arrangement of a calibration surface near an axial grinding worm end,

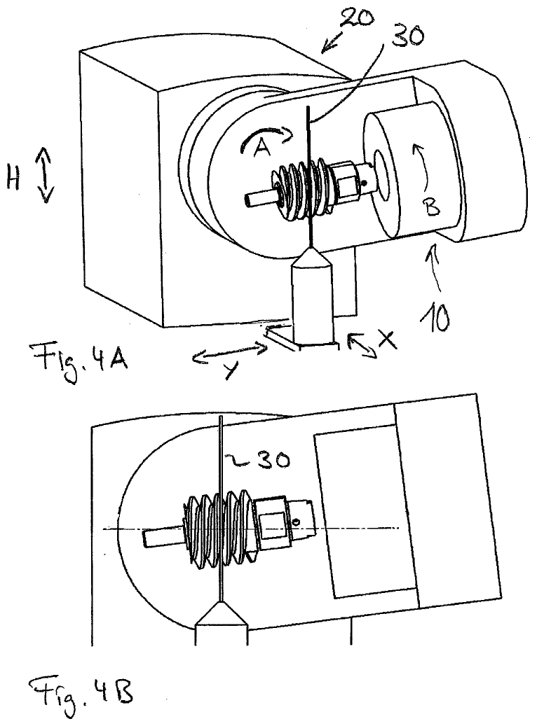

FIGS. 4A, 4B depict the positioning of a profiling means with respect to the worm thread orientation.

First, a machining sequence for the initial profiling of a grinding worm is described using FIG. 1 in the sequence 1A to 1C. A blank for the future grinding worm 1 of initially cylindrical shape and with completely unmachined surface 2 is pre-profiled in a given rotational position of the worm rotation axis B in an initial profiling region 3. The worm threads in region 3 are created by cutting into the solid material, the resulting material chips fall into a bath in which the grinding worm 1 is at least partially immersed for profiling. This process is repeated several times in a rotated position until the profiled region 3 extends over the entire circumference of the worm, wherein the cutting means is shifted from one rotational B increment to the next by the corresponding pitch proportion along the axial worm axis Z. In a given rotational position, the cutting means travels a radial-axial path s, as shown in FIG. 2.

During roughing (FIG. 1B), the rotation is continued a total of (n−1) times between two increments by an amount of 360°/n, such that a segment-like structure of polygonal character is created in the azimuthal direction, which becomes finer with increasing n. The roughing process itself may be carried out in one or more passes, that is, with different radial cutting depths, but preferably in only one pass.

The final worm geometry is preferably achieved in one or more finishing passes. These proceed substantially like the roughing passes, but preferably with finer gradations by means of driving in increments of 360°/m, with preferably m>n. In a specific example embodiment, n could be, for example, 72, and m, for example, 180. It is understood that the axial displacement in Z changes accordingly after a rotation ΔB=360°/n or 360°/m in accordance with the corresponding pitch proportion.

In one embodiment, it is provided that a flat tangential surface 6 is formed as an orientation surface on an axial end side of the worm 1, so that a straight line (g) extending parallel to the tangential surface corresponds to a worm rotation position Bo associated with this tangential plane position. This tangential surface thus serves as a calibration surface 6. It is arranged on a sleeve 16, which is arranged on a mandrel 12 just like the grinding worm 1.

The worm shown in FIG. 2 is a two-start worm, but the invention particularly preferably also provides for worms with more than one start, but is also applicable to single-start worms. In the multi-start case, path s crosses the multiple starts one after the other, and the profiling is not performed start by start, but in terms of azimuthal regions, and thus multiple starts in one profiling pass.

As can be seen from FIGS. 4A and 4B, at the profiling position, the grinding worm 1 is not only rotatable about its own axis with rotation axis B, but also pivotable with pivot axis A. Via pivot axis A, the grinding worm 1 may be moved to a pivot position (Ao), where the worm threads 4 extend toward the processing side along a predetermined orientation, which corresponds to a height axis H in the example embodiment according to FIG. 4. In this vertical alignment, the pivot angle Ao thus corresponds to the pitch angle of the grinding worm 1. In FIG. 4A, a pivoting unit for pivoting the grinding worm is identified with reference numeral 20, and a rotating unit for rotating the grinding worm 1 about its own axis is identified with reference numeral 10. In this example embodiment, both HSK profiling mandrels for the grinding worm 1 and an adapter coupling for clamping are designed in a stainless steel version. For the sake of simplicity, neither the bath, where the profiling process takes place, nor its edges are depicted in FIG. 4A, B.

In this example embodiment, the design of the grinding worm 1 comprises a radially inner steel body which carries an outer body made of bronze or brass with CBN abrasive grains bonded therein. In this example embodiment, the outer diameter during initial profiling is 80 mm and that of the steel body is 55 mm. Accordingly, the grinding worm may be reprofiled over a radial depth of 12.5 mm minus the thread depth. The reprofiling itself is performed in a way very similar to the initial profiling described above, except that it may be sufficient to carry out the finishing (FIG. 1C), although wherein a zero position for the subsequent positioning of the profiling means may be found beforehand using the calibration surface 6. However, this calibration surface is merely a specific variant of a calibration device for retrieving the worm rotational position, and the invention is not limited thereto. Roughing may also be performed prior to reprofiling.

In this example embodiment, the grinding mechanism for profiling is electrical discharge machining, and specifically, the method of wire eroding is used. In FIG. 4A, B, the wire for the wire eroding process is identified with reference numeral 30, and its diameter is preferably in the range of 0.05 mm to 0.5 mm. Accordingly, the grinding worm 1 is wetted with liquid at least in the region of its machining (the liquid serves as a dielectric medium for the process), and an electrical voltage is applied between the erosion wire 30 and the conductive material M of the grinding worm 1 that is to be removed. For example, the eroding machine could be a standard commercial eroding machine, which, however, would have to be modified to provide the intended rotation and pivot axes (B, A), such as realized by the combined pivot and rotation unit (20, 10) as shown in FIG. 4A. In addition, the eroding wire 30 may be moved relative to the worm 1 along the linear movement axes X, Y shown in FIG. 4A in order to travel along path s (FIG. 2).

Furthermore, the grinding worm 1 may have different regions along its axial extension with regard to its cutting performance or grain size. For example, a roughing grain may be used in a first axial region, and a finishing grain, that is, a finer grain, may be used in a second axial region. For example, it may be realized that one metallic binding material that binds the abrasive grains is provided with a coarse filling and one with a fine filling. However, reprofiling of both regions may be done in one pass. Alternatively, two separately manufactured disks could be combined to form a combination tool.

In a simple design, the unit with the pivoting unit 20 and the rotating unit 10 is arranged such that the entire grinding worm 1 is immersed in a bath with a liquid, preferably water, as dielectric medium, wherein the liquid may also be a special liquid or oil in accordance with its function acting as an EDM dielectric medium.

After reprofiling, the grinding worm 1 may be returned to the generating grinding machine and continue to be used.

The above specifications are intended to illustrate the invention and are not to be construed as limiting the following claims.

1. A method for the hard-fine machining of gear teeth on workpieces using geometrically undefined cutting edges by means of generating grinding, in which a grinding worm with bonded abrasive grains made of CBN or diamond, is brought into machining engagement with a gear tooth at a machining position and is reprofiled after machining one or more workpieces of a workpiece batch, thereby undergoing material removal and thus reducing the center pitch diameter of the grinding worm before it is used for additional machining, wherein during the reprofiling, a profiling means (30) is positioned relative to the worm thread orientation by means of a rotary axis (A),
characterized in that the material removal takes place at a profiling position which differs from the machining position, with removal of a metallic material (M) that binds the abrasive grains.

2. The method according to claim 1, wherein the material removal takes place by carrying out a relative movement between the profiling means and the grinding worm, said movement including at least two movement axes.

3. The method according to claim 1, wherein the grinding worm is rotated/turned (B) about its axis during the material removal or in phases of interrupted material removal.

4. The method according to claim 1 wherein heat involved in the material removal is dissipated via a liquid.

5. The method according to claim 1 wherein a calibration device for retrieving a defined rotational angular position of the grinding worm in a profiling device in the profiling position is provided and wherein by means of the calibration device, a worm thread orientation in the reprofiling region may be set, via the rotary axis, in a predetermined direction (g) with respect to a plane extending orthogonally to the worm rotation axis.

6. The method according to claim 5, wherein the profiling means has a region under tensile stress along the predetermined direction, said region extending longitudinally along the predetermined direction.

7. The method according to claim 1 wherein continuously consecutive portions of the profiling means enter the region of material removal in a continuously consecutive fashion.

8. The method according to claim 1 wherein the material removal is carried out by means of electrical discharge machining by means of wire eroding.

9. A hard-fine machining tool using geometrically undefined cutting edges in the form of a grinding worm for the generating grinding of gears for a method according to claim 1.

10. (canceled)

11. A profiling device for profiling a grinding worm according to claim 1 comprising a positioning device (20) having a rotary axis (A) for the relative positioning of a profiling means with respect to the worm thread orientation, and liquid-filled receiving space for receiving at least one region of the grinding worm undergoing material removal as well as an abrasive region of the profiling means (30).

12. The profiling device according to claim 11, comprising a device (10) for rotating the grinding worm about its own axis of rotation and an additional positioning system with at least two additional degrees of freedom of movement for the relative position between the grinding worm and the profiling means, wherein one degree of freedom has a movement component in the plane extending orthogonally to the worm rotation axis and the other additional degree of freedom has at least one directional component parallel to the worm rotation axis.

13. The profiling device according to claim 12, comprising a controller which, in an operating mode with a positioned rotary axis and a positioned rotational position of the grinding worm, allows a relative movement along a zigzag path(s) involving the two additional degrees of freedom of movement and corresponding to the worm profile in axial section.

14. The profiling device according to claim 11 wherein a control device of the profiling device, in a second operating mode, superimposes superimposed movements (δA, δB, δX, δY) of a positioning (A₀, Bₘ) and a zigzag path(s), in order to subject the surfaces of the worm threads to a modification which modifies a profile angle modification, a profile line crowning, a tip and/or root relief, in order to create a corresponding modification on the generating-ground workpiece during generating grinding with the grinding worm profiled in this modified way, wherein the modification profiled onto the grinding worm includes a coordinated superposition of these modifications, and the modification includes a correction compensating for the additional profiling and the resulting changed center pitch diameter.

15. A use of a profiling device according to claim 11 for manufacturing a grinding worm wherein a grinding worm blank is machined by the profiling means and the grinding worm threads are thereby formed for the first time.

16. The method according to claim 1 wherein a polygon-like surface structure in the circumferential direction of the generating grinding worm is created during reprofiling.

17. The method of claim 1 wherein said grinding worm comprises a multi-start grinding worm.

18. The method of claim 2 wherein said at least two movement axes comprises linear movement axes (X, Y).

19. The method of claim 4 wherein both the profiling means (30) and the worm region that is currently being reprofiled are immersed in a liquid bath.

20. The method of claim 5 wherein the calibration device comprises a mandrel that can only be clamped in a defined rotational position and supports the worm in a defined rotational position.

21. The method of claim 5 wherein the calibration device comprises a planar tangential plane surface region that is provided axially subsequent to an axial worm end and extending orthogonally to the radial direction on the worm rotation axis.
